(19) United States
(12) Patent Application Publication
(10) Pub. No.: US 2004/0197559 A1
(43) Pub. Date: Oct. 7, 2004

(54) Silicon nitride material and making method

(76) Inventors: Yasushi Takai, Takefu-shi (JP); Yuji Kimura, Takefu-shi (JP)

Correspondence Address: BIRCH STEWART KOLASCH & BIRCH, PO BOX 747, FALLS CHURCH, VA, 22040-0747, US

(21) Appl. No.: 10/817,924

(22) Filed: Apr. 6, 2004

(30) Foreign Application Priority Data
Apr. 7, 2003 (JP) 2003-102632

(51) Int. Cl. B32B 17/02

(52) U.S. Cl. 428/404; 428/403

(57) ABSTRACT

A silicon nitride material in the form of silicon nitride particles which are coated on their entire surface with 0.1% to less than 10% by weight, calculated as oxide, of a water-insoluble metal compound containing a rare earth element, alkaline earth element or aluminum. The silicon nitride material is sinterable into an article which has a very uniform distribution of a grain boundary phase and drastically improved strength at elevated temperatures and can find use as various heat-resistant parts.

### BACKGROUND OF THE INVENTION

1. Field of the Invention

This invention relates to a silicon nitride material which is readily sinterable and suitable as a raw material for the manufacture of silicon nitride ceramics serving as structural ceramics, especially silicon nitride ceramics having an improved temperature strength, and a method of preparing the same.

2. Background Art

Because of their excellent properties including strength, toughness and corrosion resistance, silicon nitride ceramics now find ever spreading applications in a variety of fields as structural material and mechanical parts. Silicon nitride ceramics are generally manufactured by a power mixing method involving grinding an oxide such as Y₂O₃ or Al₂O₃ as a sintering aid in a ball mill or the like, and adding 2 to 10% by weight of the milled oxide to a silicon nitride fine powder of submicron order, followed by sintering. The sintering aid forms a low-melting compound at the grain boundary to promote sintering, helping produce silicon nitride ceramics having a nearly theoretical density. The power mixing method, however, often entails segregation of a grain boundary phase, which causes the silicon nitride ceramics to degrade temperature strength and prevents their application to gas turbine members or the like.

To prevent segregation of a grain boundary phase, a variety of methods of uniformly dispersing the sintering aid in silicon nitride have been proposed. For example, JP-A 62-30668, JP-A 64-69569 and JP-A 3-69546 disclose different methods of mixing silicon nitride fine powder in a solution of a metal compound serving as a sintering aid, followed by drying. However, the once dissolved compound precipitates as crystals having a size of micron order or larger. These methods thus fail to achieve sufficient dispersion. JP-A 60-235768 and JP-B 61-50908 disclose methods of dispersing silicon nitride fine powder in a solution of a metal compound serving as a sintering aid, and adding a precipitant thereto to form an insoluble metal compound precipitate. However, the precipitate forms irregularly. These methods yet fail to achieve sufficient dispersion.

### SUMMARY OF THE INVENTION

An object of the invention is to provide a silicon nitride material in which entire surfaces of silicon nitride particles are uniformly coated with a sintering aid element which is necessary to yield silicon nitride ceramics having an improved temperature strength.

Making investigations on precipitation conditions in a solution of a water-soluble metal compound containing an element serving as a sintering aid, we have discovered that in urea-assisted homogeneous precipitation reaction in a metal compound solution having silicon nitride powder dispersed therein, a desirable distribution of the metal is achieved only under certain conditions. We have also discovered that when this concept is applied to silicon nitride powder having certain properties, a silicon nitride ceramic having an improved temperature strength due to minimized segregation of a grain boundary phase is obtained.

In one aspect, the present invention provides a silicon nitride material comprising silicon nitride particles which are coated on their entire surface with 0.1% to less than 10% by weight, calculated as oxide, of a water-insoluble metal compound containing at least one metal element selected from the group consisting of rare earth elements, alkaline earth elements and aluminum.

In a preferred embodiment, on XPS analysis, the concentration of the metal element at a depth of 10 nm from the particle surface is at least twice the concentration of the metal element at a depth of 200 nm. In another preferred embodiment, on EPMA analysis, a dispersion coefficient of the metal element is from 0.1 to less than 0.4. Preferably, the silicon nitride particles which are coated with a water-insoluble metal compound have a particle size variance of 0.1 to less than 0.7. Also preferably, the silicon nitride particles have an average particle size of 0.1 μm to less than 3 μm. In a preferred embodiment, the silicon nitride has a beta conversion of 0.01% to less than 10%. The water-insoluble metal compound is typically a metal oxide.

In another aspect, the present invention provides a method of preparing a silicon nitride material comprising the steps of dispersing silicon nitride particles in an aqueous solution of a water-soluble compound containing at least one metal element selected from the group consisting of rare earth elements, alkaline earth elements and aluminum, heating the dispersion at a temperature of at least 80° C., introducing urea to the dispersion within 5 minutes while stirring, allowing the dispersion to ripen at a temperature of at least 80° C., and optionally, firing the resulting silicon nitride material in air.

### BRIEF DESCRIPTION OF THE DRAWINGS

FIG. 1 is a diagram showing the results of XPS analysis on the silicon nitride material obtained in Example 1.

FIG. 2 is a diagram showing the results of XPS analysis on the silicon nitride material obtained in Comparative Example 2.

### DESCRIPTION OF THE PREFERRED EMBODIMENTS

The silicon nitride material of the invention is in the form of silicon nitride particles which are coated on their entire surface with 0.1% to less than 10% by weight, calculated as oxide, of a water-insoluble metal compound containing at least one metal element selected from the group consisting of rare earth elements, alkaline earth elements and aluminum. Less than 0.1% by weight of the water-insoluble metal compound is insufficient to promote sintering, resulting in a silicon nitride ceramic having a reduced strength. At least 10% by weight of the water-insoluble metal compound allows a more than necessity amount of grain boundary phase to form, resulting in a silicon nitride ceramic having a reduced temperature strength. As used herein, the term “temperature strength” refers to strength at an elevated temperature, for example, flexural strength at 1,400° C., unless otherwise stated.

The rare earth elements include Sc, Y, La, Ce, Pr, Nd, Sm, Eu, Tb, Dy, Ho, Er, Tm, Yb, and Lu. The water-insoluble metal compounds are those compounds which are insoluble or substantially insoluble in water, and include oxides, hydroxides and carbonates (inclusive of basic carbonates) of metal elements selected from among rare earth elements, alkaline earth elements and aluminum.

X-ray photoelectron spectroscopy (XPS) is able to quantitatively analyze whether or not the water-insoluble metal compound covers the entire surface of a silicon nitride particle in a depth direction thereof. In a preferred embodiment, the concentration of the metal element at a depth of 10 nm from the particle surface is at least twice the concentration of the metal element at a depth of 200 nm. It is noted that the metal element concentration at a depth of 10 nm divided by the metal element concentration at a depth of 200 nm is referred to as a concentration ratio. A concentration ratio of less than 2 indicates that surfaces of silicon nitride particles are not fully coated with the metal element, allowing for more segregation of a grain boundary phase and resulting in a sintered body with a reduced temperature strength. Quantitative analysis at a certain depth is performed by XPS analysis of a sample whose surface has been etched by a predetermined thickness. At this point, in order to eliminate the influence of gas components or the like adsorbed to the surface, the surface which has been etched by a thickness of 10 nm is considered as the outermost surface. The preferred concentration ratio is at least 3. The upper limit of concentration ratio is not critical and is theoretically infinite although the ratio is usually up to 10.

It can also be ascertained by analysis of an element distribution by electron probe microanalysis (EPMA) that the entire surfaces of silicon nitride particles are coated with the water-insoluble metal compound. More particularly, when the silicon nitride material of the invention is subjected to area analysis by EPMA, the metal element concentration calculated preferably has a coefficient of variation of less than 0.4, especially equal to or less than 0.3. A coefficient of variation of equal to or more than 0.4 indicates that silicon nitride and the metal element are non-uniformly distributed in a range of several microns. This means that some silicon nitride particles are coated on their entire surface with the metal element, but some are not, allowing greater segregation of the metal element at the grain boundary in a sintered body and resulting in a reduced temperature strength. The lower limit of coefficient of variation is usually at least 0.1, though not critical.

Also preferably, the silicon nitride particles which are coated with the water-insoluble metal compound have a particle size variance of less than 0.7, especially equal to or less than 0.5. A particle size variance of equal to or more than 0.7 indicates a broad particle size distribution, which impedes to form a dense compact in the course of sintered body manufacture, resulting in a sintered body with a lower density and hence, a reduced strength. The lower limit of particle size variance is usually at least 0.1, though not critical. It is preferred that the particle size variance of silicon nitride particles be kept substantially unchanged before and after they are coated with the water-insoluble metal compound. More preferably, a change of variance before and after coating is equal to or less than 0.1. In the invention, the particle size distribution of silicon nitride particles is kept substantially unchanged before and after they are coated with the water-insoluble metal compound. The particle size variance is defined by the equation:

Particle size variance=(D90−D10)/(D90+D10)

wherein D90 (a 90 percentile of particle diameter) indicates that 90% of the particles have a diameter less than the assigned value, and D10 (a 10 percentile of particle diameter) indicates that 10% of the particles have a diameter less than the assigned value.

Also preferably, the silicon nitride particles have an average particle size of 0.1 μm to less than 3 μm. An average particle size of less than 0.1 μm may allow for abnormal grain growth during sintering, resulting in a sintered body with a low strength. An average particle size of 3 μm or greater may retard the progress of sintering, resulting in a sintered body with a low strength as well.

Also preferably, the silicon nitride particles have a beta conversion of less than 10%, especially equal to or less than 5%. A beta conversion of 10% or greater may lead to more segregation of a grain boundary phase in a sintered body, resulting in a reduced temperature strength.

Now it is described how to prepare the silicon nitride material of the invention.

The silicon nitride material is prepared by first mixing and dispersing silicon nitride powder in an aqueous solution of a water-soluble compound containing at least one metal element selected from among rare earth elements, alkaline earth elements and aluminum to form a dispersion liquid. The compound used herein is selected from water-soluble compounds such as chlorides, nitrates, sulfates and organic acid salts.

Preferably the dispersion has a silicon nitride concentration of 1% to less than 50% by weight. A concentration of equal to or less than 1% by weight may make the production process inefficient whereas effective dispersion may become difficult at a concentration of 50% by weight or more. Also preferably the metal compound concentration in the dispersion liquid is adjusted such that the metal element, calculated as oxide, is 0.1% to less than 10%, especially 1% to 8% by weight based on the silicon nitride.

Next, the dispersion is heated at a temperature of at least 80° C., after which urea is introduced while stirring. The key feature of the method is the timing of urea addition. In case where urea is mixed with and dissolved in the dispersion prior to heating, after which the mixture is heated at or above 80° C. to induce decomposition of urea and precipitation of a water-insoluble metal compound, the decomposition of urea gradually takes place over a temperature range of 60 to 80° C., allowing less nuclei of the water-insoluble metal compound to form so that the water-insoluble metal compound grows to a larger particle diameter. It is then unlikely that the metal compound completely covers surfaces of silicon nitride particles. In the practice of the invention, the dispersion is heated to a temperature of at least 80° C. which can promote rapid decomposition of urea, after which urea is quickly added. This sequence ensures that a large number of metal compound nuclei having a size of nanometer order form and adsorb to surfaces of silicon nitride particles to cover the entire surfaces.

The temperature at which urea is introduced into the dispersion liquid is preferably 90° C. or higher, more preferably 95° C. or higher. The higher the liquid temperature at the time of urea addition, the more rapidly takes place the decomposition of urea. This insures the generation of more nuclei and the full coverage of particle surfaces. The upper limit of temperature is the boiling point of the dispersion liquid under atmospheric pressure. The upper limit temperature at the time of urea addition is preferably 98° C. or lower.

In the event the metal element is a rare earth or aluminum, the amount of urea fed is preferably 6 moles to less than 18 moles per mole of the metal element. Less than 6 moles of urea may be insufficient to drive the precipitation reaction to completion whereas 18 moles or more of urea is economically wasteful. Within the above-defined range, a more amount of urea is preferred because the decomposition of urea takes place rapidly to enhance nucleus generation and increase the coverage of particle surfaces. It is thus more preferred to add at least 9 moles of urea. In the event the metal element is an alkaline earth element, it is preferred for the same reason that the amount of urea fed be 4 moles to less than 12 moles per mole of the metal element, especially at least 6 moles per mole of the metal element. In the event the metal element is a combination of elements of both the groups, the amount of urea fed may be determined by proportional calculation.

In this step, urea is introduced to the dispersion within 5 minutes, especially within 1 minute. If the time taken for introduction is in excess of 5 minutes, a less number of nuclei generate, failing to fully cover surfaces of silicon nitride particles with the metal compound. A lower limit need not be imposed on the feed time. For increasing the amount of nuclei generated, it is preferred to feed urea as quickly as possible with any feed system.

Urea may be in the form of a solid or an aqueous solution. Introduction of urea in solid form is recommended for minimizing a temperature drop of the liquid by urea introduction. When urea is introduced in solid form, granular form is preferred for quick completion of dissolution. Granular urea with a particle size of 0.1 mm to less than 3 mm is preferred. Granules of less than 0.1 mm size tend to cake during storage whereas granules of equal to or more than 3 mm may require a longer time to dissolve, resulting in a less amount of nuclei being generated.

After the introduction of urea, the dispersion is held at a temperature from 80° C. to less than the boiling point to bring the precipitation reaction to completion. The holding temperature is preferably at least 90° C., more preferably at least 95° C., for the same reason as described previously. The holding time is preferably 30 minutes to 12 hours, especially 1 to 3 hours.

Thereafter, the dispersed particles were filtered, washed with water, and dried or fired in air, yielding a silicon nitride material within the scope of the invention. Since the metal compound covering silicon nitride particles is in the form of a hydroxide or carbonate, it is preferably converted into an oxide form by firing, in order to avoid gas generation upon subsequent sintering. The firing temperature is preferably the minimum temperature above which the metal compound is decomposed into an oxide. Firing at a higher than necessity temperature is undesirable because the agglomeration of particles or the decomposition of silicon nitride can be induced. Specifically the firing temperature is in a range of 600 to 900° C. The firing is preferably performed in an oxidizing atmosphere or air and for a time of 30 minutes to about 24 hours.

### EXAMPLE

Examples of the invention are given below by way of illustration and not by way of limitation.

### Example 1

In 7 kg of an aqueous yttrium nitrate solution having an yttrium concentration of 0.03 mol/kg, 296.4 g of a silicon nitride powder (SN-E10 by Ube Industries, Ltd., beta conversion <5%, average particle size=0.55 μm, particle size variance=0.42) was mixed and dispersed. The dispersion liquid was heated to 95° C. With stirring, 208.1 g of urea was fed to the dispersion within about 10 seconds. The dispersion was held at 95° C. for one hour for ripening. The ripened dispersion was cooled, after which the dispersed particles were suction filtered and washed with 1 kg of deionized water. The resulting cake was dried at 100° C. and fired in air at 700° C. for 2 hours, yielding a yttrium oxide-coated silicon nitride material.

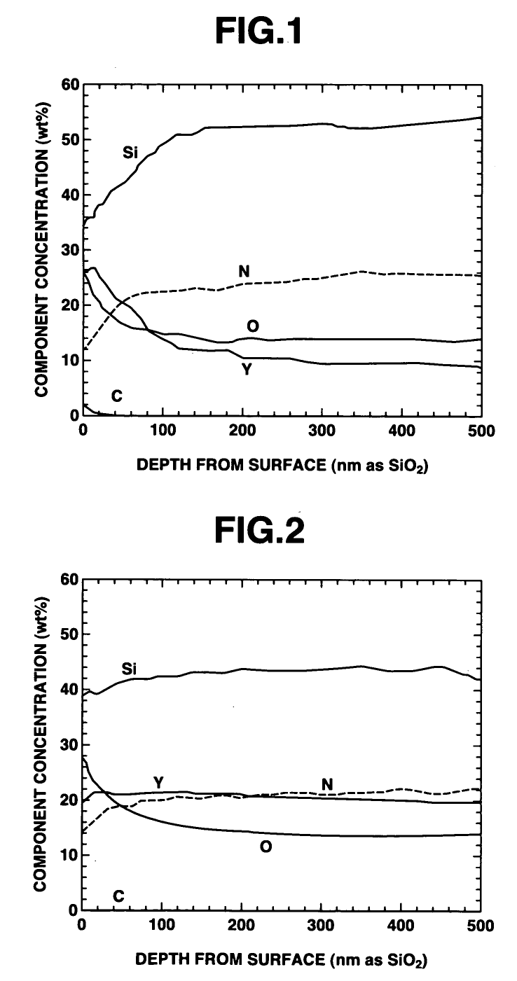

The results of XPS analysis on the silicon nitride material are shown in FIG. 1. The ratio of the yttrium concentration at a depth of 10 nm to the yttrium concentration at a depth of 200 nm was 2.6. From the results of EPMA on the silicon nitride material, the coefficient of variation of yttrium was 0.25. The particle size distribution of the yttrium oxide-coated silicon nitride material was determined by the laser diffraction method (Microtrac FRA by Leeds & Northrup, refractive index 1.81, ultrasonic dispersion 40 W×3 min), finding D50=0.58 μm and a particle size variance of 0.45.

The silicon nitride material obtained above was pressed in a mold and then by cold isostatic pressing (CIP), into a disc having a diameter of 60 mm and a thickness of 10 mm. The disc was sintered in a N₂ atmosphere at a pressure of 8 kgf/cm² and 1,850° C. for 3 hours. The sintered disc was cut into a specimen of 4×3×40 mm. The specimen was examined at room temperature (RT) and 1,400° C. by a four-point flexural strength test according to JIS R-1601. The results are shown in Table 1.

### Example 2

A yttrium oxide-coated silicon nitride material was prepared as in Example 1 except that the urea feed time was 3 minutes. The test results are also shown in Table 1.

### Comparative Example 1

The procedure of Example 1 was repeated except that urea was fed to the silicon nitride dispersion liquid at room temperature and dissolved therein, after which the dispersion liquid was heated up to 95° C. over about 30 minutes and held at 95° C. for one hour for ripening. The test results are also shown in Table 1.

### Comparative Example 2

A 2-liter zirconia pot YTZ® (Nikkato Corp.) was charged with 312.5 g of silicon nitride powder (SN-E10, Ube Kosan Co., Ltd.), 25 g of yttrium oxide (Shin-Etsu Chemical Co., Ltd., average particle diameter=1 μm), 730 g of deionized water, and 1 kg of zirconia balls YTZ® having a diameter of 5 mm (Nikkato Corp.). The ingredients were milled for 24 hours. The resulting dispersion liquid was cooled and suction filtered. The cake was dried at 100° C., yielding a yttrium oxide-coated silicon nitride material.

The results of XPS analysis on the silicon nitride/yttrium oxide mixed material are shown in FIG. 2. The ratio of the yttrium concentration at a depth of 10 nm to the yttrium concentration at a depth of 200 nm was 1.1. From the results of EPMA on the mixed material, the coefficient of variation of yttrium was 0.51. The material was further evaluated as in Example 1, with the results shown in Table 1.

TABLE 1

| | XPS | EPMA | | | |
|---|---|---|---|---|---|
| | (Y concentration | (coefficient | | Flexural | Flexural |
| | at 10 nm depth/ | of | Relative | strength | strength |
| | Y concentration | variation | density | at RT | at 1400° C. |
| | at 200 nm depth) | of Y) | (%) | (kg/mm²) | (kg/mm²) |
| Example 1 | 2.6 | 0.25 | 99 | 102 | 95 |
| Example 2 | 2.2 | 0.34 | 98 | 98 | 89 |
| Comparative | 1.5 | 0.43 | 97 | 83 | 70 |
| Example 1 | | | | | |
| Comparative | 1.1 | 0.51 | 95 | 65 | 46 |
| Example 2 | | | | | |

There has been described a silicon nitride material in which silicon nitride particles are fully surface coated with a sintering aid element. It is sinterable into an article which has a very uniform distribution of a grain boundary phase and drastically improved strength at elevated temperature and can find use as various heat-resistant parts.

Japanese Patent Application No. 2003-102632 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silicon nitride material comprising silicon nitride particles which are coated on their entire surface with 0.1% to less than 10% by weight, calculated as oxide, of a water-insoluble metal compound containing at least one metal element selected from the group consisting of rare earth elements, alkaline earth elements and aluminum.

2. The silicon nitride material of claim 1 wherein on XPS analysis, the concentration of the metal element at a depth of 10 nm from the particle surface is at least twice the concentration of the metal element at a depth of 200 nm.

3. The silicon nitride material of claim 1 wherein on EPMA analysis, a dispersion coefficient of the metal element is from 0.1 to less than 0.4.

4. The silicon nitride material of claim 1 wherein the silicon nitride particles which are coated with a water-insoluble metal compound have a particle size variance of 0.1 to less than 0.7.

5. The silicon nitride material of claim 1 wherein the silicon nitride particles have an average particle size of 0.1 μm to less than 3 μm.

6. The silicon nitride material of claim 1 wherein the silicon nitride has a beta conversion of 0.01% to less than 10%.

7. The silicon nitride material of claim 1 wherein the water-insoluble metal compound is a metal oxide.

8. A method of preparing a silicon nitride material comprising the steps of:
dispersing silicon nitride particles in an aqueous solution of a water-soluble compound containing at least one metal element selected from the group consisting of rare earth elements, alkaline earth elements and aluminum,
heating the dispersion at a temperature of at least 80° C.,
introducing urea to the dispersion within 5 minutes while stirring, and
allowing the dispersion to ripen at a temperature of at least 80° C.

9. The method of claim 8, further comprising the step of firing the silicon nitride material in air.
